(19) United States
(12) Patent Application Publication
(10) Pub. No.: US 2021/0141239 A1
(43) Pub. Date: May 13, 2021

(54) DIFFRACTIVE LIGHT PROJECTION DEVICE

(71) Applicant: EVERREADY PRECISION IND. CORP., Kaohsiung City (TW)

(72) Inventors: CHENG-HUNG CHI, Taichung City (TW); CHIH-MING YEN, Taipei City (TW)

(21) Appl. No.: 16/744,640

(22) Filed: Jan. 16, 2020

(30) Foreign Application Priority Data
Nov. 8, 2019 (TW) 108140693

(51) Int. Cl. G02B 27/42

(52) U.S. Cl. CPC G02B 27/4288; G02B 27/4233

(57) ABSTRACT

A diffractive light projection device includes a light source and a diffractive optical module. The light source emits a light beam. After the light beam passes through the diffractive optical module, a diffractive light is outputted from the diffractive optical module. The diffractive optical module includes plural diffractive optical elements, which are arranged in a stack form and made of different materials. Consequently, a usable wavelength range of the light beam is expanded. Since the usable wavelength range of the light beam to be incident on the diffractive optical module is expanded, the degree of freedom for designing the diffractive optical module is increased.

### FIELD OF THE INVENTION

The present invention relates to an optical apparatus, and more particularly to a diffractive light projection device.

### BACKGROUND OF THE INVENTION

With the development of electronic industries and the advance of industrial technologies, various electronic products are designed toward small size, light weightiness and easy portability. Consequently, these electronic products can be applied to mobile business, entertainment or leisure purposes whenever or wherever the users are. In recent years, the manufacturers pay much attention on the integration and application of mechanic, optical and electrical technologies. Consequently, various kinds of optical apparatuses are widely applied to various electronic products such as smart phones, wearable electronic products or any other small-sized and portable electronic products. Consequently, the users can take these electronic products whenever they need. In other words, these electronic products not only have important commercial values but also provide more colorful lives to people.

Moreover, with the increase of the living quality, people hope that the electronic products have diversified functions. Consequently, the optical apparatuses for the electronic products have to meet more demands (e.g., the demand on the 3D sensing function). For meeting these demands, some techniques about a diffractive optical element have been disclosed. FIG. 1 schematically illustrates the concept of using a structural light technology to perform the 3D sensing operation. After the laser light beam L11 from a laser light source 11 passes through a collimating unit 13, the collimated laser light beam L11′ is directed to a diffractive optical element 12. After the collimated laser light beam L11′ is transferred through the diffractive optical element 12, a structured light L12 is outputted. Consequently, a corresponding structured light pattern 14 is shown in the space for performing the 3D sensing operation. As shown in FIG. 1, the structured light pattern 14 is a dot pattern.

FIG. 2 schematically illustrates the concept of using a TOF (Time of Flight) technology to perform the 3D sensing operation. As shown in FIG. 2, plural laser light sources 21 emit the laser light beams L21. After the laser light beams L21 are shaped by a diffractive optical element 22, the laser light beams L21 are uniformly scattered to a field of view (FOV) in the space for the TOF measurement.

Generally, the laser light source has a specified tolerance when the laser light source is manufactured in the factory. Because of the tolerance, the center wavelengths of the laser light beams from the same-specification laser light sources are usually different. Moreover, the additional influence of the temperature in the environment, the difference between the center wavelengths may reach several ten nanometers (nm). Since the diffractive optical element is sensitive to the wavelength of the diffractive light that is incident on the diffractive optical element, the diffractive optical element has the wavelength selection property. In other words, the applications of the diffractive optical element are limited by the diffraction properties thereof.

Generally, the diffraction efficiency of the single-layered diffractive optical element may be expressed by the following mathematic formula:

$$\begin{matrix}η ( λ ) = {sinc}^{2} \{ \frac{φ ( λ )}{2 π} - 1 \} \\ = {sinc}^{2} \{ ( \frac{2 π}{λ} \cdot h \cdot Δ n ) \cdot \frac{1}{2 π} - 1 \} \\ = {sinc}^{2} \{ ( \frac{2 π}{λ} \cdot \frac{{λ}_{0}}{n ( {λ}_{0} ) - {n}_{air}} \cdot ( n ( λ ) - {n}_{air} ) ) \cdot \frac{1}{2 π} - 1 \} ;\end{matrix}$$

In the above mathematic formula, X is the wavelength of the laser light beams incident on the diffractive optical element, λ₀ is the designed wavelength of the diffractive optical element, η(λ) is the diffraction efficiency of the diffractive optical element with respect to the wavelength λ, φ(λ) is an optical path difference (phase difference) with respect to the wavelength λ, h is the maximum height of the diffractive optical element, n(λ) and n(λ₀) are the refraction indexes of the diffractive optical element with respect to the wavelength λ and the wavelength λ₀, and nₐᵢᵣ is the refraction index of the air with respect to the wavelength λ and the wavelength λ₀. If the wavelength λ of the laser light beam incident on the diffractive optical element is identical to the designed wavelength λ₀ of the diffractive optical element, the theoretical value of the diffraction efficiency may be expressed as sinc²{1−1}=100%.

FIG. 3 is a plot illustrating the relationship between the diffraction efficiency of a single-layered diffractive optical element and the wavelength, in which the diffractive optical element is made of polycarbonate (PC) and the designed wavelength λ₀=436.8 nm. As mentioned above and as shown in FIG. 3, the diffractive optical element has the higher diffraction efficiency (e.g., 77.64%) when the wavelength of the laser light beam is 436.8 nm. As the wavelength increases, the diffraction efficiency decreases. That is, the usable wavelength range of the single-layered diffractive optical element is very narrow. For achieving the better diffraction efficiency, the wavelength λ of the laser light beam incident on the diffractive optical element should be close to the designed wavelength λ₀ of the diffractive optical element.

FIG. 4 is a plot illustrating the relationship between the zero-order diffraction efficiency of a diffractive optical element and the wavelength. In case that the wavelength of the laser light beam from the laser light source is different from the designed wavelength of the diffractive optical element, the strong zero-order beam effect is generated (see the arrowed region as shown in FIG. 5) or the signal-to-noise ratio (SNR) is reduced (see the arrowed region as shown in FIG. 6). In other words, the conventional diffractive optical element

### SUMMARY OF THE INVENTION

For overcoming the drawbacks of the conventional technologies, the present invention provides a diffractive light projection device. Consequently, the usable wavelength range of the light beam to be incident on the diffractive optical module is expanded, and the degree of freedom for designing the diffractive optical module is increased.

In accordance with an aspect of the present invention, a diffractive light projection device is provided. The diffractive light projection device includes a light source and a diffractive optical module. The light source emits a light beam. After the light beam passes through the diffractive optical module, a diffractive light is outputted from the diffractive optical module. The diffractive optical module includes a first diffractive optical element and a second diffractive optical element. The first diffractive optical element and the second diffractive optical element are arranged in a stack form and made of different materials. Consequently, a usable wavelength range of the light beam is expanded.

In an embodiment, the first diffractive optical element has a first light-inputting surface and a first light-outputting surface, and the second diffractive optical element has a second light-inputting surface and a second light-outputting surface. After the light beam is transferred through the first light-inputting surface, the first light-outputting surface, the second light-inputting surface and the second light-outputting surface sequentially, the diffractive light is outputted from the diffractive optical module.

In an embodiment, a first microstructure is formed on the first light-outputting surface, a second microstructure is formed on the second light-inputting surface, and a shape of the first microstructure and a shape of the second microstructure are complementary to each other. Alternatively, the first microstructure is formed on the first light-inputting surface, the second microstructure is formed on the second light-outputting surface, and the shape of the first microstructure and the shape of the second microstructure are complementary to each other.

In an embodiment, the first microstructure and the second microstructure are multi-level microstructures with plural levels, and widths of any two complementary levels of the first microstructure and the second microstructure are equal.

In an embodiment, the first light-outputting surface and the second light-inputting surface are separated from each other by a distance.

In an embodiment, the usable wavelength range is a range between a first wavelength and a second wavelength, the first diffractive optical element has a first refraction index with respect to the first wavelength, the first diffractive optical element has a second refraction index with respect to the second wavelength, the second diffractive optical element has a third refraction index with respect to the first wavelength, and the second diffractive optical element has a fourth refraction index with respect to the second wavelength. A maximum height of the first diffractive optical element and a maximum height of the second diffractive optical element satisfy following formulae:

$${h}_{1} = \frac{{λ}_{1} \cdot ( {n}_{2} ( {λ}_{2} ) - 1 ) - {λ}_{2} \cdot ( {n}_{2} ( {λ}_{1} ) - 1 )}{( {n}_{1} ( {λ}_{1} ) - 1 ) \cdot ( {n}_{2} ( {λ}_{2} ) - 1 ) - ( {n}_{1} ( {λ}_{2} ) - 1 ) \cdot ( {n}_{2} ( {λ}_{1} ) - 1 )} , \\ {h}_{2} = \frac{{λ}_{1} \cdot ( {n}_{1} ( {λ}_{2} ) - 1 ) - {λ}_{2} \cdot ( {n}_{1} ( {λ}_{1} ) - 1 )}{( {n}_{1} ( {λ}_{1} ) - 1 ) \cdot ( {n}_{2} ( {λ}_{2} ) - 1 ) - ( {n}_{1} ( {λ}_{2} ) - 1 ) \cdot ( {n}_{2} ( {λ}_{1} ) - 1 )}$$

wherein h₁ is the maximum height of the first diffractive optical element, h₂ is the maximum height of the second diffractive optical element, λ₁ is the first wavelength, λ₂ is the second wavelength, n₁(λ) is the first refraction index, n₂(λ) is the second refraction index, n₂(λ₁) is the third refraction index, and n₂(λ₂) is the fourth refraction index.

In an embodiment, the first light-outputting surface and the second light-inputting surface are attached on each other.

In an embodiment, the usable wavelength range is a range between a first wavelength and a second wavelength, the first diffractive optical element has a first refraction index with respect to the first wavelength, the first diffractive optical element has a second refraction index with respect to the second wavelength, the second diffractive optical element has a third refraction index with respect to the first wavelength, and the second diffractive optical element has a fourth refraction index with respect to the second wavelength. The diffractive optical module satisfies the following formula:

$$\frac{{λ}_{1}}{{λ}_{2}} \cdot \frac{{n}_{1} ( {λ}_{2} ) - {n}_{2} ( {λ}_{2} )}{{n}_{1} ( {λ}_{1} ) - {n}_{2} ( {λ}_{1} )} = 1 ;$$

wherein λ₁ is the first wavelength, λ₂ is the second wavelength, n₁(λ) is the first refraction index, n₂(λ) is the second refraction index, n₂(λ₁) is the third refraction index, and n₂(λ₂) is the fourth refraction index.

In an embodiment, the diffractive light projection device is installed in a 3D sensing system or a biometric identification system.

In accordance with another aspect of the present invention, a diffractive light projection device is provided. The diffractive light projection device includes a light source and a diffractive optical module. The light source emits a light beam. After the light beam passes through the diffractive optical module, a diffractive light is outputted from the diffractive optical module. The diffractive optical module includes a first diffractive optical element and a second diffractive optical element. The first diffractive optical element and the second diffractive optical element are arranged in a stack form and made of different materials. A usable wavelength range of the light beam is a range between a first wavelength and a second wavelength. A difference between the second wavelength and the first wavelength is at least 50 nm. A diffraction efficiency difference of the diffractive optical module with respect to any two wavelengths in the usable wavelength range is smaller than 0.5%.

In an embodiment, the first diffractive optical element has a first light-inputting surface and a first light-outputting surface, and the second diffractive optical element has a second light-inputting surface and a second light-outputting surface. After the light beam is transferred through the first light-inputting surface, the first light-outputting surface, the second light-inputting surface and the second light-outputting surface sequentially, the diffractive light is outputted from the diffractive optical module.

In an embodiment, a first microstructure is formed on the first light-outputting surface, a second microstructure is formed on the second light-inputting surface, and a shape of the first microstructure and a shape of the second microstructure are complementary to each other. Alternatively, the first microstructure is formed on the first light-inputting surface, the second microstructure is formed on the second light-outputting surface, and the shape of the first microstructure and the shape of the second microstructure are complementary to each other.

In an embodiment, the first microstructure and the second microstructure are multi-level microstructures with plural levels, and widths of any two complementary levels of the first microstructure and the second microstructure are equal.

In an embodiment, the first light-outputting surface and the second light-inputting surface are separated from each other by a distance.

In an embodiment, the first diffractive optical element has a first refraction index with respect to the first wavelength, the first diffractive optical element has a second refraction index with respect to the second wavelength, the second diffractive optical element has a third refraction index with respect to the first wavelength, and the second diffractive optical element has a fourth refraction index with respect to the second wavelength. A maximum height of the first diffractive optical element and a maximum height of the second diffractive optical element satisfy following formulae:

$${h}_{1} = \frac{{λ}_{1} \cdot ( {n}_{2} ( {λ}_{2} ) - 1 ) - {λ}_{2} \cdot ( {n}_{2} ( {λ}_{1} ) - 1 )}{( {n}_{1} ( {λ}_{1} ) - 1 ) \cdot ( {n}_{2} ( {λ}_{2} ) - 1 ) - ( {n}_{1} ( {λ}_{2} ) - 1 ) \cdot ( {n}_{2} ( {λ}_{1} ) - 1 )} , \\ {h}_{2} = \frac{{λ}_{1} \cdot ( {n}_{1} ( {λ}_{2} ) - 1 ) - {λ}_{2} \cdot ( {n}_{1} ( {λ}_{1} ) - 1 )}{( {n}_{1} ( {λ}_{1} ) - 1 ) \cdot ( {n}_{2} ( {λ}_{2} ) - 1 ) - ( {n}_{1} ( {λ}_{2} ) - 1 ) \cdot ( {n}_{2} ( {λ}_{1} ) - 1 )}$$

wherein h₁ is the maximum height of the first diffractive optical element, h₂ is the maximum height of the second diffractive optical element, λ₁ is the first wavelength, λ₂ is the second wavelength, n₁(λ) is the first refraction index, n₂(λ) is the second refraction index, n₂(λ₁) is the third refraction index, and n₂(λ₂) is the fourth refraction index.

In an embodiment, the first light-outputting surface and the second light-inputting surface are attached on each other.

In an embodiment, the first diffractive optical element has a first refraction index with respect to the first wavelength, the first diffractive optical element has a second refraction index with respect to the second wavelength, the second diffractive optical element has a third refraction index with respect to the first wavelength, and the second diffractive optical element has a fourth refraction index with respect to the second wavelength. The diffractive optical module satisfies the following formula:

$$\frac{{λ}_{1}}{{λ}_{2}} \cdot \frac{{n}_{1} ( {λ}_{2} ) - {n}_{2} ( {λ}_{2} )}{{n}_{1} ( {λ}_{1} ) - {n}_{2} ( {λ}_{1} )} = 1 ;$$

wherein λ₁ is the first wavelength, λ₂ is the second wavelength, n₁(λ) is the first refraction index, n₂(λ) is the second refraction index, n₂(λ₁) is the third refraction index, and n₂(λ₂) is the fourth refraction index.

In an embodiment, the diffractive light projection device is installed in a 3D sensing system or a biometric identification system.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the concept of using a structural light technology to perform the 3D sensing operation;

FIG. 2 schematically illustrates the concept of using a TOF (Time of Flight) technology to perform the 3D sensing operation;

FIG. 3 is a plot illustrating the relationship between the diffraction efficiency of a single-layered diffractive optical element and the wavelength, in which the diffractive optical element is made of polycarbonate (PC) and the designed wavelength λ₀=436.8 nm;

FIG. 4 is a plot illustrating the relationship between the zero-order diffraction efficiency of a diffractive optical element and the wavelength;

FIG. 5 schematically illustrates a strong zero-order beam effect generated by the single-layered diffractive optical element;

FIG. 6 schematically illustrates a signal-to-noise ratio (SNR) reduced by the single-layered diffractive optical element;

FIG. 7 is a schematic functional block diagram illustrating a diffractive light projection device according to a first embodiment of the present invention;

FIG. 8 schematically illustrates the structure of the diffractive light projection device as shown in FIG. 7;

FIG. 9 schematically illustrates the structure of a diffractive optical module of the diffractive light projection device according to a second embodiment of the present invention;

FIG. 10 schematically illustrates of a diffractive optical module of the diffractive light projection device according to a third embodiment of the present invention;

FIG. 11 is a plot illustrating the diffraction efficiency of the diffractive optical module as shown in FIG. 10 in the wavelength range between 436.8 nm and 633.7 nm;

FIG. 12 is a plot illustrating the zero-order diffraction efficiency of the diffractive optical module as shown in FIG. 10 in the wavelength range between 436.8 nm and 633.7 nm;

FIG. 13 schematically illustrates of a diffractive optical module of the diffractive light projection device according to a fourth embodiment of the present invention;

FIG. 14 schematically illustrates of a diffractive optical module of the diffractive light projection device according to a fifth embodiment of the present invention; and

FIG. 15 schematically illustrates of a diffractive optical module of the diffractive light projection device according to a sixth embodiment of the present invention.

### DETAILED DESCRIPTION OF THE PREFERRED EMBODIMENT

The embodiments of present invention will be described more specifically with reference to the following drawings. Generally, in the drawings and specifications, identical or similar components are designated by identical numeral references. For well understanding the present invention, the elements shown in the drawings are not in scale with the elements of the practical product. In the following embodiments and drawings, the elements irrelevant to the concepts of the present invention or the elements well known to those skilled in the art are omitted. It is noted that numerous modifications and alterations may be made while retaining the teachings of the invention.

Please refer to FIGS. 7 and 8. FIG. 7 is a schematic functional block diagram illustrating a diffractive light projection device according to a first embodiment of the present invention. FIG. 8 schematically illustrates the structure of the diffractive light projection device as shown in FIG. 7. The diffractive light projection device 3 comprises a light source 31 and a diffractive optical module 32. The light source 31 emits a light beam L31. Preferably but not exclusively, the light source 31 is a laser light source. After the light beam L31 is emitted by the light source 31, the light beam L31 is transferred through the diffractive optical module 32. Consequently, a diffractive light L32 is outputted from the diffractive optical module 32.

Moreover, the diffractive optical module 32 comprises a first diffractive optical element 321 and a second diffractive optical element 322, which are arranged in a stack form. The first diffractive optical element 321 has a first light-inputting surface 3211 and a first light-outputting surface 3212. The second diffractive optical element 322 has a second light-inputting surface 3221 and a second light-outputting surface 3222. After the light beam L31 from the light source 31 is inputted into the diffractive optical module 32, the light beam L31 is transferred through the first light-inputting surface 3211, the first light-outputting surface 3212, the second light-inputting surface 3221 and the second light-outputting surface 3222 sequentially. Then, the diffractive light L32 is outputted from the diffractive optical module 32. Moreover, plural first microstructures 32121 are formed on the first light-outputting surface 3212, and plural second microstructures 32211 are formed on the second light-inputting surface 3221. The shape of each first microstructure 32121 and the shape of the corresponding second microstructure 32211 are complementary to each other.

In this embodiment, the first light-outputting surface 3212 and the second light-inputting surface 3221 are separated from each other by a distance. Moreover, the first microstructure 32121 and the second microstructure 32211 are four-level microstructures. The widths of any two complementary levels of the first microstructure 32121 and the second microstructure 32211 are equal. It is noted that that the number of the diffractive optical elements, the shape of the first microstructure and the shape of the second microstructure are not restricted. That is, the number of the diffractive optical elements, the shape of the first microstructure and the shape of the second microstructure may be varied according to the practical requirements.

In this embodiment, the first diffractive optical element 321 and the second diffractive optical element 322 are made of difference materials. Consequently, the first diffractive optical element 321 and the second diffractive optical element 322 have different refraction indexes with respect to the same wavelength. Consequently, the usable wavelength range of the light beam L31 to be inputted into the diffractive optical module 32 is expanded by the first diffractive optical element 321 and the second diffractive optical element 322 collaboratively. The associated principles will be described later. Preferably but not exclusively, the length of the usable wavelength range of the light beam L31 exceeds 50 nanometers according to the structural design of the diffractive optical module 32. Moreover, by the diffractive optical module 32, the diffraction efficiency difference of the diffractive optical module 32 with respect to any two wavelengths in the usable wavelength range is smaller than 0.5%.

FIG. 9 schematically illustrates of a diffractive optical module of the diffractive light projection device according to a second embodiment of the present invention. In comparison with the first embodiment, the first light-outputting surface 4212 of the first diffractive optical element 421 and the second light-inputting surface 4221 of the second diffractive optical element 422 in the diffractive optical module 42 of this embodiment are attached on each other. In addition, the first microstructure on the first light-outputting surface 4212 and the second microstructure on the second light-inputting surface 4221 are two-level microstructures. The structures of the other components of the diffractive light projection device in this embodiment are similar to those of the first embodiment, and are not redundantly described herein.

Moreover, the diffraction efficiency of the diffractive optical module 42 may be expressed as the following mathematical formulae:

$$\begin{matrix}η ( {λ}_{2} ) = {sinc}^{2} \{ \frac{φ ( {λ}_{2} )}{2 π} - 1 \} \\ = {sinc}^{2} \{ ( \frac{2 π}{{λ}_{2}} \cdot h \cdot Δ n ) \cdot \frac{1}{2 π} - 1 \} \\ = {sinc}^{2} \{ ( \frac{2 π}{{λ}_{2}} \cdot \frac{{λ}_{1}}{{n}_{1} ( {λ}_{1} ) - {n}_{2} ( {λ}_{1} )} \cdot ( {n}_{1} ( {λ}_{2} ) - {n}_{2} ( {λ}_{2} ) ) ) \cdot \frac{1}{2 π} - 1 \} \\ = {sinc}^{2} \{ \frac{{λ}_{1}}{{λ}_{2}} \cdot \frac{{n}_{1} ( {λ}_{2} ) - {n}_{2} ( {λ}_{2} )}{{n}_{1} ( {λ}_{1} ) - {n}_{2} ( {λ}_{1} )} - 1 \} ;\end{matrix}$$

$$φ ( {λ}_{2} ) = {φ}_{0} ( {λ}_{2} ) \cdot \frac{Level - 1}{Level} ;$$

In the above mathematic formulae, λ₂ is the wavelength of the light beam L41 (i.e., a second wavelength in this embodiment) incident on the diffractive optical module 42, λ₁ is the designed wavelength of the diffractive optical module 42, η(λ) is the diffraction efficiency of the diffractive optical module 42 with respect to the wavelength λ₂, and φ(λ₂) is an optical path difference (phase difference) with respect to the wavelength λ₂ when the phases of the first light-outputting surface 4212 and the second light-inputting surface 4221 are continuous. Since the first light-outputting surface 4212 and the second light-inputting surface 4221 have the two-level phases, φ₀(λ₂) is modified as φ(λ₂) and Level=2. Moreover, in the above mathematic formulae, h is the maximum height of the diffractive optical module 42 (i.e., the same height is shared by the first diffractive optical element and the second diffractive optical element), n₁(λ₁) and n₁(λ₂) are the refraction indexes of the first diffractive optical element 421 with respect to the wavelength λ₁ and the wavelength λ₂, and n₂(λ₁) and n₂(λ₂) are the refraction indexes of the second diffractive optical element 422 with respect to the wavelength λ₁ and the wavelength λ₂. In this embodiment, n₁(λ₁) is a first refraction index, n₁(λ₂) is the second refraction index, n₂(λ₁) is a third refraction index, and n₂(λ₂) is a fourth refraction index.

Consequently, the theoretical value of the diffraction efficiency may be expressed as sinc²{1−1}=100% if the diffractive optical module 42 satisfies the following mathematic formula:

$$\frac{{λ}_{1}}{{λ}_{2}} \cdot \frac{{n}_{1} ( {λ}_{2} ) - {n}_{2} ( {λ}_{2} )}{{n}_{1} ( {λ}_{1} ) - {n}_{2} ( {λ}_{1} )} = 1 ;$$

In other words, if the ratio of the first wavelength λ₁ to the second wavelength λ₂ (i.e., λ₁/λ₂) is equal to the ratio of the refraction index difference between the first diffractive optical element 421 and the second diffractive optical element 422 with respect to the first wavelength λ₁ (i.e., n₁(λ₁)−n₂(λ₁)) to the refraction index difference between the first diffractive optical element 421 and the second diffractive optical element 422 with respect to the second wavelength λ₂ (i.e., n₁(λ₂)−n₂(λ₂)), the theoretical values of the diffraction efficiency of the diffractive optical module 42 with respect to the first wavelength λ₁ and the second wavelength λ₂ are both 100%. Moreover, the diffraction efficiency of the diffractive optical module 42 with respect to any other wavelength between the first wavelength λ₁ and the second wavelength λ₂ is enhanced. Consequently, the usable wavelength range of the diffractive optical module 42 at least contains the range between the first wavelength λ₁ and the second wavelength λ₂.

As mentioned above, it is preferred that the ratio λ₁/λ₂ is equal to the ratio (n₁(λ₁)−n₂(λ₁))/(n₁(λ₂)−n₂(λ₂)). However, for achieving this purpose, the selection on the material of the diffractive optical element 421 and the material of the second diffractive optical element 422 is limited. For solving this drawback, the diffractive optical module can be modified. In the following embodiment, a diffractive optical module 52 is provided.

FIG. 10 schematically illustrates of a diffractive optical module of the diffractive light projection device according to a third embodiment of the present invention. In comparison with the first embodiment, the first microstructure on the first light-outputting surface 5212 of the first diffractive optical element 521 and the second microstructure on the second light-inputting surface 5221 of the second diffractive optical element 522 are two-level microstructures. The structures of the other components of the diffractive light projection device in this embodiment are similar to those of the first embodiment, and are not redundantly described herein.

Moreover, the diffraction efficiency of the diffractive optical module 52 may be expressed as the following mathematical formulae:

$$\begin{matrix}η ( λ ) = {sinc}^{2} \{ \frac{φ ( λ )}{2 π} - 1 \} \\ = {sinc}^{2} \{ ( \frac{2 π}{λ} \cdot [ {h}_{1} \cdot ( {n}_{1} ( λ ) - 1 ) - {h}_{2} \cdot ( {n}_{2} ( λ ) - 1 ) ] \cdot \frac{1}{2 π} - 1 \} ,\end{matrix}$$

$$φ ( λ ) = {φ}_{0} ( λ ) \cdot \frac{Level - 1}{Level} ;$$

In the above mathematic formulae, λ is the wavelength of the light beam L51 incident on the diffractive optical module 52, η(λ) is the diffraction efficiency of the diffractive optical module 52 with respect to the wavelength λ, and φ₀(λ) is an optical path difference (phase difference) with respect to the wavelength λ when the phases of the first light-outputting surface 5212 and the second light-inputting surface 5221 are continuous. Since the first light-outputting surface 5212 and the second light-inputting surface 5221 have the two-level phases, φ₀(λ₂) is modified as φ(λ₂) and Level=2. Moreover, h₁ is the maximum height of the first diffractive optical element 521, h₂ is the maximum height of the second diffractive optical element 522, n₁(λ) is the refraction index of the first diffractive optical element 521 with respect to the wavelength λ, and n₂(λ) is the refraction index of the second diffractive optical element 522 with respect to the wavelength λ.

As mentioned above, if h₁·(n₁(λ)−1)−h₂·(n₂(λ)−1)=λ, the theoretical value of the diffraction efficiency may be expressed as sinc²{1−1}=100%. Consequently, if the maximum height h₁ of the first diffractive optical element 521 and the maximum height h₂ of the second diffractive optical element 522 satisfy the following mathematic formulae, the theoretical values of the diffraction efficiency of the diffractive optical module 52 with respect to the wavelength λ₁ (i.e., the first wavelength of the first embodiment) and the wavelength λ₂ (i.e., the second wavelength of the second embodiment) of the incident light beam L51 are both 100%. Moreover, the diffraction efficiency of the diffractive optical module 52 with respect to any other wavelength between the first wavelength λ₁ and the second wavelength λ₂ is enhanced. Consequently, the usable wavelength range of the diffractive optical module 52 at least contains the range between the first wavelength λ₁ and the second wavelength λ₂. The mathematic formulae are expressed as:

$${h}_{1} = \frac{{λ}_{1} \cdot ( {n}_{2} ( {λ}_{2} ) - 1 ) - {λ}_{2} \cdot ( {n}_{2} ( {λ}_{1} ) - 1 )}{( {n}_{1} ( {λ}_{1} ) - 1 ) \cdot ( {n}_{2} ( {λ}_{2} ) - 1 ) - ( {n}_{1} ( {λ}_{2} ) - 1 ) \cdot ( {n}_{2} ( {λ}_{1} ) - 1 )} , \\ {h}_{2} = \frac{{λ}_{1} \cdot ( {n}_{1} ( {λ}_{2} ) - 1 ) - {λ}_{2} \cdot ( {n}_{1} ( {λ}_{1} ) - 1 )}{( {n}_{1} ( {λ}_{1} ) - 1 ) \cdot ( {n}_{2} ( {λ}_{2} ) - 1 ) - ( {n}_{1} ( {λ}_{2} ) - 1 ) \cdot ( {n}_{2} ( {λ}_{1} ) - 1 )} ;$$

In the above mathematic formulae, n₁(λ₁) and n₁(λ₂) are the refraction indexes of the first diffractive optical element 521 with respect to the wavelength λ₁ and the wavelength λ₂, and n₂(λ₁) and n₂(λ₂) are the refraction indexes of the second diffractive optical element 522 with respect to the wavelength λ₁ and the wavelength λ₂. In this embodiment, n₁(λ₁) is a first refraction index, n₁(λ₂) is the second refraction index, n₂(λ₁) is a third refraction index, and n₂(λ₂) is a fourth refraction index.

Hereinafter, two examples of the diffractive optical module will be described.

In a first example, the usable wavelength range of the light beam L51 to be incident on the diffractive optical module 52 at least contains the range between 436.8 nm (i.e., the first wavelength λ₁) and 633.7 nm (i.e., the second wavelength λ₂). For achieving this usable wavelength range, the first diffractive optical element 521 is made of polymethyl methacrylate (PMMA), and the second diffractive optical element 522 is made of polycarbonate (PC). The refraction index of the first diffractive optical element 521 with respect to the first wavelength λ₁ is 1.502 (i.e., the first refraction index), and the refraction index of the first diffractive optical element 521 with respect to the second wavelength λ₂ is 1.489 (i.e., the second refraction index). The refraction index of the second diffractive optical element 522 with respect to the first wavelength λ₁ is 1.611 (i.e., the third refraction index), and the refraction index of the second diffractive optical element 522 with respect to the second wavelength λ₂ is 1.58 (i.e., the fourth refraction index). Consequently, the maximum height h₁ of the first diffractive optical element 521 is 9.1461 micrometers (μm), and the maximum height h₂ of the second diffractive optical element 522 is 7.1548 micrometers (μm).

Due to the above structural design, the diffraction efficiency of the diffractive optical module 52 is enhanced. FIG. 11 is a plot illustrating the diffraction efficiency of the diffractive optical module as shown in FIG. 10 in the wavelength range between 436.8 nm (i.e., the first wavelength λ₁) and 633.7 nm (i.e., the second wavelength λ₂). FIG. 12 is a plot illustrating the zero-order diffraction efficiency of the diffractive optical module as shown in FIG. 10 in the wavelength range between 436.8 nm (i.e., the first wavelength λ₁) and 633.7 nm (i.e., the second wavelength λ₂). According to the result of comparing FIG. 3 with FIG. 11 and the result of comparing FIG. 4 with FIG. 12, the usable wavelength range of the light beam L51 to be incident on the diffractive optical module 52 is largely expanded.

In a second example, the usable wavelength range of the light beam L51 to be incident on the diffractive optical module 52 at least contains the range between 486.1 (i.e., the first wavelength λ₁) and 587.6 nm (i.e., the second wavelength λ₂). The material of the first diffractive optical element 521 is selected such that the refraction index of the first diffractive optical element 521 with respect to the first wavelength λ₁ is 1.6848 (i.e., the first refraction index), and the refraction index of the first diffractive optical element 521 with respect to the second wavelength λ₂ is 1.6613 (i.e., the second refraction index). The material of the second diffractive optical element 522 is selected such that the refraction index of the second diffractive optical element 522 with respect to the first wavelength λ₁ is 1.55134 (i.e., the third refraction index) and the refraction index of the second diffractive optical element 522 with respect to the second wavelength λ₂ is 1.5445 (i.e., the fourth refraction index). Consequently, the maximum height h₁ of the first diffractive optical element 521 is 7.1667 micrometers (μm), and the maximum height h₂ of the second diffractive optical element 522 is 9.7831 micrometers (μm).

In the diffractive optical module 32 of the first embodiment, the first microstructures 32121 are formed on the first light-outputting surface 3212 of the first diffractive optical element 321, and the second microstructures 32211 are formed on the second light-inputting surface 3221 of the second diffractive optical element 322. It is noted that numerous modifications and alterations may be made while retaining the teachings of the invention. For example, a variant example of the diffractive optical module is shown in FIG. 13. In the diffractive optical module 32′ of FIG. 13, the plural first microstructures 32121′ are formed on the first light-inputting surface 3211′ of the first diffractive optical element 321′, and plural second microstructures 32211′ are formed on the second light-outputting surface 3222′ of the second diffractive optical element 322′.

In the diffractive optical module 42 of the second embodiment, the first microstructures are formed on the first light-outputting surface 4212 of the first diffractive optical element 421, and the second microstructures are formed on the second light-inputting surface 4221 of the second diffractive optical element 422. It is noted that numerous modifications and alterations may be made while retaining the teachings of the invention. For example, a variant example of the diffractive optical module is shown in FIG. 14. In the diffractive optical module 42′ of FIG. 14, the plural first microstructures are formed on the first light-inputting surface 4211′ of the first diffractive optical element 421′, and plural second microstructures are formed on the second light-outputting surface 4222′ of the second diffractive optical element 422′.

In the diffractive optical module 52 of the third embodiment, the first microstructures are formed on the first light-outputting surface 5212 of the first diffractive optical element 521, and the second microstructures are formed on the second light-inputting surface 5221 of the second diffractive optical element 522. It is noted that numerous modifications and alterations may be made while retaining the teachings of the invention. For example, a variant example of the diffractive optical module is shown in FIG. 15. In the diffractive optical module 52′ of FIG. 15, the plural first microstructures are formed on the first light-inputting surface 5211′ of the first diffractive optical element 521′, and plural second microstructures are formed on the second light-outputting surface 5222′ of the second diffractive optical element 522′.

From the above descriptions, the diffractive optical module of the diffractive light projection device of the present invention comprises plural diffractive optical elements in multiple layers. The diffractive optical elements in multiple layers have different refraction indexes with respect to different wavelengths, and the diffractive optical elements have respective wavelengths. Consequently, the usable wavelength range of the light beam to be incident on the diffractive optical module is expanded, and the degree of freedom for designing the diffractive optical module is increased. In other words, the diffractive light projection device of the present invention is industrially valuable. Preferably, the diffractive optical elements in multiple layers are stacked in an insert manner Since the combined structure is compact, the dust-proof and waterproof benefits are achieved.

Especially, the diffractive light projection device of the present invention can be applied to a 3D sensing system or a biometric identification system. It is noted that the applications of the diffractive light projection device are not restricted. Moreover, the usable wavelength range of the light beam to be incident on the diffractive optical module is expanded. Consequently, if the wavelength of the light beam outputted from the diffractive light projection device is shifted or unqualified, the sensing quality of the 3D sensing system or the identifying quality of the biometric identification system is not adversely affected. Consequently, the problem of generating the strong zero-order beam effect (see the arrowed region as shown in FIG. 5) or the problem of reducing the signal-to-noise ratio (SNR) (see the arrowed region as shown in FIG. 6) will be effectively overcome.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A diffractive light projection device, comprising:
a light source emitting a light beam; and
a diffractive optical module, wherein after the light beam passes through the diffractive optical module, a diffractive light is outputted from the diffractive optical module, wherein the diffractive optical module comprises a first diffractive optical element and a second diffractive optical element, and the first diffractive optical element and the second diffractive optical element are arranged in a stack form and made of different materials, so that a usable wavelength range of the light beam is expanded.

2. The diffractive light projection device according to claim 1, wherein the first diffractive optical element has a first light-inputting surface and a first light-outputting surface, and the second diffractive optical element has a second light-inputting surface and a second light-outputting surface, wherein after the light beam is transferred through the first light-inputting surface, the first light-outputting surface, the second light-inputting surface and the second light-outputting surface sequentially, the diffractive light is outputted from the diffractive optical module.

3. The diffractive light projection device according to claim 2, wherein a first microstructure is formed on the first light-outputting surface, a second microstructure is formed on the second light-inputting surface, and a shape of the first microstructure and a shape of the second microstructure are complementary to each other; or wherein the first microstructure is formed on the first light-inputting surface, the second microstructure is formed on the second light-outputting surface, and the shape of the first microstructure and the shape of the second microstructure are complementary to each other.

4. The diffractive light projection device according to claim 3, wherein the first microstructure and the second microstructure are multi-level microstructures with plural levels, and widths of any two complementary levels of the first microstructure and the second microstructure are equal.

5. The diffractive light projection device according to claim 2, wherein the first light-outputting surface and the second light-inputting surface are separated from each other by a distance.

6. The diffractive light projection device according to claim 5, wherein the usable wavelength range is a range between a first wavelength and a second wavelength, the first diffractive optical element has a first refraction index with respect to the first wavelength, the first diffractive optical element has a second refraction index with respect to the second wavelength, the second diffractive optical element has a third refraction index with respect to the first wavelength, and the second diffractive optical element has a fourth refraction index with respect to the second wavelength, wherein a maximum height of the first diffractive optical element and a maximum height of the second diffractive optical element satisfy following formulae:
$${h}_{1} = \frac{{λ}_{1} \cdot ( {n}_{2} ( {λ}_{2} ) - 1 ) - {λ}_{2} \cdot ( {n}_{2} ( {λ}_{1} ) - 1 )}{( {n}_{1} ( {λ}_{1} ) - 1 ) \cdot ( {n}_{2} ( {λ}_{2} ) - 1 ) - ( {n}_{1} ( {λ}_{2} ) - 1 ) \cdot ( {n}_{2} ( {λ}_{1} ) - 1 )} , \\ {h}_{2} = \frac{{λ}_{1} \cdot ( {n}_{1} ( {λ}_{2} ) - 1 ) - {λ}_{2} \cdot ( {n}_{1} ( {λ}_{1} ) - 1 )}{( {n}_{1} ( {λ}_{1} ) - 1 ) \cdot ( {n}_{2} ( {λ}_{2} ) - 1 ) - ( {n}_{1} ( {λ}_{2} ) - 1 ) \cdot ( {n}_{2} ( {λ}_{1} ) - 1 )} ;$$
wherein h₁ is the maximum height of the first diffractive optical element, h₂ is the maximum height of the second diffractive optical element, λ₁ is the first wavelength, λ₂ is the second wavelength, n₁(λ) is the first refraction index, n₂(λ) is the second refraction index, n₂(λ₁) is the third refraction index, and n₂(λ₂) is the fourth refraction index.

7. The diffractive light projection device according to claim 2, wherein the first light-outputting surface and the second light-inputting surface are attached on each other.

8. The diffractive light projection device according to claim 7, wherein the usable wavelength range is a range between a first wavelength and a second wavelength, the first diffractive optical element has a first refraction index with respect to the first wavelength, the first diffractive optical element has a second refraction index with respect to the second wavelength, the second diffractive optical element has a third refraction index with respect to the first wavelength, and the second diffractive optical element has a fourth refraction index with respect to the second wavelength, wherein the diffractive optical module satisfies the following formula:
$$\frac{{λ}_{1}}{{λ}_{2}} \cdot \frac{{n}_{1} ( {λ}_{2} ) - {n}_{2} ( {λ}_{2} )}{{n}_{1} ( {λ}_{1} ) - {n}_{2} ( {λ}_{1} )} = 1 ;$$
wherein λ₁ is the first wavelength, λ₂ is the second wavelength, n₁(λ) is the first refraction index, n₂(λ) is the second refraction index, n₂(λ₁) is the third refraction index, and n₂(λ₂) is the fourth refraction index.

9. The diffractive light projection device according to claim 1, wherein the diffractive light projection device is installed in a 3D sensing system or a biometric identification system.

10. A diffractive light projection device, comprising:
a light source emitting a light beam; and
a diffractive optical module, wherein after the light beam passes through the diffractive optical module, a diffractive light is outputted from the diffractive optical module, wherein the diffractive optical module comprises a first diffractive optical element and a second diffractive optical element, and the first diffractive optical element and the second diffractive optical element are arranged in a stack form and made of different materials, wherein a usable wavelength range of the light beam is a range between a first wavelength and a second wavelength, a difference between the second wavelength and the first wavelength is at least 50 nm, and a diffraction efficiency difference of the diffractive optical module with respect to any two wavelengths in the usable wavelength range is smaller than 0.5%.

11. The diffractive light projection device according to claim 10, wherein the first diffractive optical element has a first light-inputting surface and a first light-outputting surface, and the second diffractive optical element has a second light-inputting surface and a second light-outputting surface, wherein after the light beam is transferred through the first light-inputting surface, the first light-outputting surface, the second light-inputting surface and the second light-outputting surface sequentially, the diffractive light is outputted from the diffractive optical module.

12. The diffractive light projection device according to claim 11, wherein a first microstructure is formed on the first light-outputting surface, a second microstructure is formed on the second light-inputting surface, and a shape of the first microstructure and a shape of the second microstructure are complementary to each other; or wherein the first microstructure is formed on the first light-inputting surface, the second microstructure is formed on the second light-outputting surface, and the shape of the first microstructure and the shape of the second microstructure are complementary to each other.

13. The diffractive light projection device according to claim 12, wherein the first microstructure and the second microstructure are multi-level microstructures with plural levels, and widths of any two complementary levels of the first microstructure and the second microstructure are equal.

14. The diffractive light projection device according to claim 11, wherein the first light-outputting surface and the second light-inputting surface are separated from each other by a distance.

15. The diffractive light projection device according to claim 14, wherein the first diffractive optical element has a first refraction index with respect to the first wavelength, the first diffractive optical element has a second refraction index with respect to the second wavelength, the second diffractive optical element has a third refraction index with respect to the first wavelength, and the second diffractive optical element has a fourth refraction index with respect to the second wavelength, wherein a maximum height of the first diffractive optical element and a maximum height of the second diffractive optical element satisfy following formulae:
$${h}_{1} = \frac{{λ}_{1} \cdot ( {n}_{2} ( {λ}_{2} ) - 1 ) - {λ}_{2} \cdot ( {n}_{2} ( {λ}_{1} ) - 1 )}{( {n}_{1} ( {λ}_{1} ) - 1 ) \cdot ( {n}_{2} ( {λ}_{2} ) - 1 ) - ( {n}_{1} ( {λ}_{2} ) - 1 ) \cdot ( {n}_{2} ( {λ}_{1} ) - 1 )} , \\ {h}_{2} = \frac{{λ}_{1} \cdot ( {n}_{1} ( {λ}_{2} ) - 1 ) - {λ}_{2} \cdot ( {n}_{1} ( {λ}_{1} ) - 1 )}{( {n}_{1} ( {λ}_{1} ) - 1 ) \cdot ( {n}_{2} ( {λ}_{2} ) - 1 ) - ( {n}_{1} ( {λ}_{2} ) - 1 ) \cdot ( {n}_{2} ( {λ}_{1} ) - 1 )} ;$$
wherein h₁ is the maximum height of the first diffractive optical element, h₂ is the maximum height of the second diffractive optical element, λ₁ is the first wavelength, λ₂ is the second wavelength, n₁(λ) is the first refraction index, n₂(λ) is the second refraction index, n₂(λ₁) is the third refraction index, and n₂(λ₂) is the fourth refraction index.

16. The diffractive light projection device according to claim 11, wherein the first light-outputting surface and the second light-inputting surface are attached on each other.

17. The diffractive light projection device according to claim 16, wherein the first diffractive optical element has a first refraction index with respect to the first wavelength, the first diffractive optical element has a second refraction index with respect to the second wavelength, the second diffractive optical element has a third refraction index with respect to the first wavelength, and the second diffractive optical element has a fourth refraction index with respect to the second wavelength, wherein the diffractive optical module satisfies the following formula:
$$\frac{{λ}_{1}}{{λ}_{2}} \cdot \frac{{n}_{1} ( {λ}_{2} ) - {n}_{2} ( {λ}_{2} )}{{n}_{1} ( {λ}_{1} ) - {n}_{2} ( {λ}_{1} )} = 1 ;$$
wherein λ₁ is the first wavelength, λ₂ is the second wavelength, n₁(λ) is the first refraction index, n₂(λ) is the second refraction index, n₂(λ₁) is the third refraction index, and n₂(λ₂) is the fourth refraction index.

18. The diffractive light projection device according to claim 10, wherein the diffractive light projection device is installed in a 3D sensing system or a biometric identification system.
